(19) United States
(12) Patent Application Publication
(10) Pub. No.: US 2015/0024185 A1
(43) Pub. Date: Jan. 22, 2015

(54) FORCE SPUN SUB-MICRON FIBER AND APPLICATIONS

(71) Applicant: SABIC GLOBAL TECHNOLOGIES B.V., Bergen op Zoom (NL)

(72) Inventors: Jacob Labelle, Pittsfield, MA (US); Richard Peters, Pittsfield, MA (US); Erich Teutsch, Pittsfield, MA (US)

(21) Appl. No.: 14/329,424

(22) Filed: Jul. 11, 2014

Related U.S. Application Data
(60) Provisional application No. 61/847,413, filed on Jul. 17, 2013.

(51) Int. Cl. D04H 3/005; B32B 5/02; B32B 27/36; D01D 5/08

(52) U.S. Cl. CPC D04H 3/005; D01D 5/08; B32B 5/022; B32B 27/365; B32B 2262/02; B32B 2262/14
USPC 428/220; 264/176.1; 264/143

(57) ABSTRACT

A process of forming a non-woven web including spinning a plurality of continuous polymeric filaments including a polycarbonate homopolymer component, a polycarbonate copolymer component, and combinations thereof at a rate of at least 300 grams/hour/spinneret.

### CROSS-REFERENCES TO RELATED APPLICATIONS

This application claims benefit under 35 U.S.C. §119(e) to U.S. Provisional Patent Application Ser. No. 61/847,413 filed on Jul. 17, 2013, which is hereby incorporated by reference in its entirety.

### BACKGROUND OF THE INVENTION

1. Field of the Invention

The invention relates generally to a process of forming forming a non-woven web including a polycarbonate homopolymer component, a polycarbonate copolymer component, and combinations thereof, and more specifically to forming the non-woven web at a rate of at least 300 grams/hour/spinneret.

2. Description of the Related Art

Polycarbonate (PC) and PC Copolymers have been converted into fibers using the melt spinning process for some time. This is capable of producing fibers in the range of 10-20 microns. Melt blown has also been used for some PC's producing fibers in the 1 to 10 micron range.

Electro-spinning of these resins is possible, but the cost of the resin and the slow throughput rate of this process have made this method commercially unacceptable. Typical production rates for this process are in the 200 to 300 grams per hour, and 60 meters per minute line speed rates.

These materials would be desirable in many applications and composite structures that require various unique properties of the different resins to perform in the necessary environment. Many of these applications require the resins to be in a fiber size much smaller than currently achievable using conventional methods of fiber production at a reasonable throughput rate. This has been a barrier to the introduction and testing of many of these resins suitability for use in these applications. It would be desirable to use these materials in nano-fiber form produced from the force spinning process in applications such as electrical paper, battery separator membranes, structural composites and filter papers, etc.

### BRIEF SUMMARY OF THE INVENTION

According to various embodiments, using a force spinning process, the above-identified materials can be either melt spun or solution spun into fiber diameters in the sub-micron range. Even small decreases in fiber diameters results in substantial increases in the surface area of the resins, thereby increasing the performance benefit that the individual resins bring to the applications. Each of these resin families have been converted to sub-micron fibers using this process. One advantage this process brings is a reasonable throughput of ultra-fine fibers enabling them to be produced in an economically viable method. Throughput rates as high as 200 to 300 thousand grams per hour are possible, with line speeds as high as 250 meters per minute and higher.

The output of this process is a non-woven web structure of continuous fiber lengths, randomly laid down onto a carrier substrate, or coated onto another functional sheet, film, non-woven or other rolled good product. The resulting product is then packaged as a rolled good to be used in further downstream processes, to produce applications such as membranes, battery separators, filtration media, composites, electrical papers, and honeycomb papers.

### BRIEF DESCRIPTION OF THE DRAWINGS

These and other features, aspects, and advantages of the present invention will become better understood with reference to the following description and appended claims, and accompanying drawings where:

FIG. 1 depicts one or more nozzles coupled to one or more openings of a known fiber producing device;

FIG. 2 shows a cross-sectional view of the known fiber producing device;

FIG. 3 is an image showing the fiber morphology obtained according to Example 1; and

FIG. 4 is an image showing the fiber morphology obtained according to Example 2.

It should be understood that the various embodiments are not limited to the arrangements and instrumentality shown in the drawings.

### DETAILED DESCRIPTION OF THE INVENTION

The invention provides a process of forming a non-woven web including spinning a plurality of continuous polymeric filaments including a polycarbonate homopolymer component, a polycarbonate copolymer component, and combinations thereof at a high rate of at least 300 grams/hour/spinneret.

The present invention may be understood more readily by reference to the following detailed description of preferred embodiments of the invention as well as to the examples included therein. All numeric values are herein assumed to be modified by the term “about,” whether or not explicitly indicated. The term “about” generally refers to a range of numbers that one of skill in the art would consider equivalent to the recited value (i.e., having the same function or result). In many instances, the term “about” may include numbers that are rounded to the nearest significant figure.

Various embodiments relate to a process of forming a non-woven web. The process can include spinning a plurality of continuous polymeric filaments including one selected from a polycarbonate homopolymer component, a polycarbonate copolymer component, and combinations thereof. The filaments can have a length to diameter ratio that can be more than 1,000,000, and a diameter ranging from 50 nanometers to 5 microns, preferably from 50 nanometers to 2 microns. The spinning can include passing a polymer through a spinneret having a plurality of orifices in a non-electrospinning environment. The process according to various embodiments can further include: chopping the plurality of continuous filaments and obtaining a plurality of chopped nano-fibers; and forming the nano-fibers into a non-woven web. The spinning can be conducted at a rate of at least 300 grams/hour/spinneret.

According to various embodiments, none of the plurality of continuous polymeric filaments are bonded to adjacent filaments. According to other embodiments, a portion of the plurality of continuous polymeric filaments can be at least partially bonded to adjacent filaments. According to other embodiments, each of the plurality of continuous polymeric filaments can be at least partially bonded to adjacent filaments. Various embodiments of the process can further include entangling the filaments. The non-woven web can contain less than 10 wt % of a material selected from polyvinyl pyrrolidine, polymethyl methacrylate, polyvinylidene fluoride, polypropylene, polyethylene oxide, agarose, polyvinylidene fluoride, polylactic glycolic acid, nylon 6, polycaprolactone, polylactic acid, polybutylene terepthalate, polyetherimide homopolymers, polyetherimide co-polymers, polyetherether ketones homopolymers, polyetherether ketones copolymers, polyphenylene sulfones homopolymers, polyphenylene sulfones copolymers, poly(phenylene ether) components, poly(phenylene ether)-polysiloxane block copolymer, and combinations thereof.

Various embodiments relate to a process including spinning a plurality of continuous polymeric filaments by passing at least one polymeric component through a spinneret having a plurality of orifices, and producing a non-woven web including the plurality of continuous polymeric filaments. The at least one polymeric component can include a polycarbonate homopolymer component, a polycarbonate copolymer component, and combinations thereof.

Each of the plurality of continuous polymeric filaments can have a length to diameter ratio within a range having a lower limit and/or an upper limit. The range can include or exclude the lower limit and/or the upper limit. The lower limit and/or upper limit can be selected from 500000, 1000000, 1500000, 2000000, 2500000, 3000000, 3500000, 4000000, 4500000, 5000000, 10000000, 15000000, 20000000, 25000000, 30000000, 35000000, 40000000, 45000000, 50000000, 55000000, 60000000, 65000000, 70000000, 75000000, 80000000, 85000000, 90000000, 95000000, 100000000, 105000000, 110000000, 115000000, 120000000, 125000000, 130000000, 135000000, 140000000, 145000000, 150000000, 155000000, 160000000, 165000000, 170000000, 175000000, 180000000, 185000000, 190000000, 195000000, 200000000, 205000000, 210000000, 215000000, 220000000, 225000000, 230000000, 235000000, 240000000, 245000000, 250000000, 255000000, 260000000, 265000000, 270000000, 275000000, 280000000, 285000000, 290000000, 295000000, and 300000000. For example, according to certain preferred embodiments, each of the plurality of continuous polymeric filaments can have a length to diameter ratio that can be more than 1,000,000.

each of the plurality of continuous polymeric filaments can have a diameter within a range having a lower limit and/or an upper limit. The range can include or exclude the lower limit and/or the upper limit. The lower limit and/or upper limit can be selected from 25, 50, 75, 100, 125, 150, 175, 200, 225, 250, 275, 300, 325, 350, 375, 400, 425, 450, 475, 500, 525, 550, 575, 600, 625, 650, 675, 700, 725, 750, 775, 800, 825, 850, 875, 900, 925, 950, 975, 1000, 1025, 1050, 1075, 1100, 1125, 1150, 1175, 1200, 1225, 1250, 1275, 1300, 1325, 1350, 1375, 1400, 1425, 1450, 1475, 1500, 1525, 1550, 1575, 1600, 1625, 1650, 1675, 1700, 1725, 1750, 1775, 1800, 1825, 1850, 1875, 1900, 1925, 1950, 1975, 2000, 2025, 2050, 2075, 2100, 2125, 2150, 2175, 2200, 2225, 2250, 2275, 2300, 2325, 2350, 2375, 2400, 2425, 2450, 2475, 2500, 2525, 2550, 2575, 2600, 2625, 2650, 2675, 2700, 2725, 2750, 2775, 2800, 2825, 2850, 2875, 2900, 2925, 2950, 2975, 3000, 3025, 3050, 3075, 3100, 3125, 3150, 3175, 3200, 3225, 3250, 3275, 3300, 3325, 3350, 3375, 3400, 3425, 3450, 3475, 3500, 3525, 3550, 3575, 3600, 3625, 3650, 3675, 3700, 3725, 3750, 3775, 3800, 3825, 3850, 3875, 3900, 3925, 3950, 3975, 4000, 4025, 4050, 4075, 4100, 4125, 4150, 4175, 4200, 4225, 4250, 4275, 4300, 4325, 4350, 4375, 4400, 4425, 4450, 4475, 4500, 4525, 4550, 4575, 4600, 4625, 4650, 4675, 4700, 4725, 4750, 4775, 4800, 4825, 4850, 4875, 4900, 4925, 4950, 4975, and 5000 nanometers. For example, according to certain preferred embodiments, each of the plurality of continuous polymeric filaments can have a diameter ranging from 50 nanometers to 5 microns, more preferably of from 50 nanometers to 2 microns.

Table 1 summarizes exemplary length to diameter ratios according to various embodiments.

TABLE 1

| Length | Diameter | |
|---|---|---|
| (in nanometers) | (in nanometers) | L/D |
| 10,000,000,000 | 50 | 200,000,000 |
| 10,000,000,000 | 100 | 100,000,000 |
| 10,000,000,000 | 500 | 20,000,000 |
| 10,000,000,000 | 1000 | 10,000,000 |
| 8,000,000,000 | 50 | 160,000,000 |
| 8,000,000,000 | 100 | 80,000,000 |
| 8,000,000,000 | 200 | 40,000,000 |
| 8,000,000,000 | 500 | 16,000,000 |
| 8,000,000,000 | 1000 | 8,000,000 |
| 5,000,000,000 | 50 | 100,000,000 |
| 5,000,000,000 | 100 | 50,000,000 |
| 5,000,000,000 | 500 | 10,000,000 |
| 5,000,000,000 | 1000 | 5,000,000 |

The non-woven web can have a width within a range having a lower limit and/or an upper limit. The range can include or exclude the lower limit and/or the upper limit. The lower limit and/or upper limit can be selected from 100, 105, 110, 115, 120, 125, 130, 135, 140, 145, 150, 155, 160, 165, 170, 175, 180, 185, 190, 195, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 600, 700, 800, 900, 1000, 1100, 1200, 1300, 1400, 1500, 1600, 1700, 1800, 1900, and 2000 mm. For example, according to certain preferred embodiments, the non-woven web can have a width of at least 150 mm.

Producing the non-woven web can include depositing the plurality of continuous filaments onto one selected from a carrier substrate, a functional sheet, a film, a non-woven, a rolled good product, and combinations thereof.

The carrier substrate can be a reciprocating belt. The process can further include solidifying the plurality of continuous polymeric filaments before the depositing step. The non-woven web can be unconsolidated. The process can further include consolidating the non-woven web. The process can further include consolidating the non-woven web under pressure.

The spinning can be conducted in a non-electrospinning environment.

The spinning can be conducted at a rate within a range having a lower limit and/or an upper limit. The range can include or exclude the lower limit and/or the upper limit. The lower limit and/or upper limit can be selected from 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350, 355, 360, 365, 370, 375, 380, 385, 390, 395, 400, 425, 450, 475, 500, 525, 550, 575, 600, 625, 650, 675, 700, 725, 750, 775, 800, 825, 850, 875, 900, 925, 950, 975, 1000, 1500, 2000, 2500, 3000, 3500, 4000, 4500, 5000, 5500, 6000, 6500, 7000, 7500, 8000, 8500, 9000, 9500, 10000, 10500, 11000, 11500, 12000, 12500, 13000, 13500, 14000, 14500, and 15000 grams/hour/spinneret. For example, according to certain preferred embodiments, the spinning can be conducted at a rate of at least 300 grams/hour/spinneret.

The spinning can be conducted by rotating the spinneret at a speed sufficient to spin the filaments under the effect of centrifugal force. FIG. 1 depicts a known fiber producing device 100, as described in WO 2012/109215, the e entirety of which is hereby incorporated by reference. As shown in FIG. 1 one or more nozzles 130 may be coupled to one or more openings 122 of fiber producing device 100. As used herein a “nozzle” is a mechanical device designed to control the direction or characteristics of a fluid flow as it exits (or enters) an enclosed chamber or pipe via an orifice. Nozzles may have an internal cavity 138 running through the longitudinal length of the nozzle, as depicted in FIG. 3. Internal cavity 138 may be substantially aligned with opening 122 when nozzle 130 is coupled to an opening. Spinning of fiber producing device 100 causes material to pass thorough one or more of openings 122 and into one or more nozzles 130. The material is then ejected from one or more nozzles 130 through nozzle orifice 136 to produce fibers. Nozzle 130 may include a nozzle tip 134 having an internal diameter smaller than an internal diameter of nozzle internal cavity 138. In some embodiments, internal cavity 138 of nozzle 130 and/or nozzle orifice 136 may have a size and/or shape that causes the creation of microfibers and/or nanofibers by ejecting of the material through the nozzle.

It should be understood that while opposing openings are depicted, the openings may be placed in any position on the body of a fiber producing device. The position of the openings may be varied to create different kinds of fibers. In some embodiments, openings may be placed in different planes of the fiber producing device. In other embodiments, openings may be clustered in certain locations. Such alternate positioning of the openings may increase the fiber dispersion patterns and/or increase the fiber production rates. In some embodiments, the openings, regardless of the position, may accept an outlet element (e.g., a nozzle or needle).

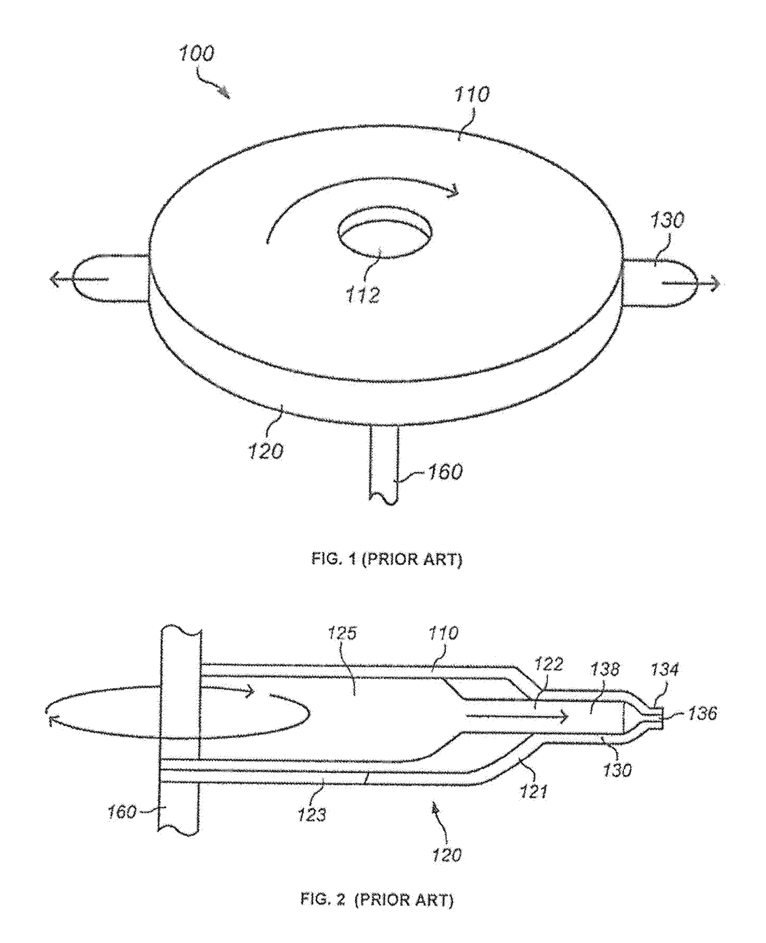

FIG. 2 shows a cross-sectional view of fiber producing device of FIG. 2. Body 120 includes one or more sidewalls 121 and a bottom 123 which together define an internal cavity 125. In one embodiment, body 120 is substantially circular or oval and includes a singular continuous sidewall 121, for example, sidewall and bottom are a single, unitary component of the fiber producing device. Openings 122 are formed in sidewall 121 of body 120, extending through the sidewall such that the opening allows transfer of material from internal cavity 125 through the sidewall. In an embodiment, sidewall 121 is angled from bottom 123 toward one or more openings 122. Alternatively, sidewall 121 may be rounded from bottom 123 toward one or more openings 122. Having an angled or rounded sidewall extending toward one or more openings facilitates flow of material in the body toward the openings when the fiber producing device is being rotated. As the fiber producing device is rotated the material rides up the angled or rounded walls toward the openings. This minimizes the occurrence of regions where material is inhibited from traveling toward the openings.

According to various embodiments, each of the plurality of continuous polymeric filaments can be provided with at least one additional functionality imparting at least one selected from therapeutic activity, catalytic activity microelectronic activity, micro-optoelectronic activity, magnetic activity, biological activity, and combinations thereof.

According to various embodiments of the process, none of the plurality of continuous polymeric filaments can be bonded to adjacent filaments. A portion of the plurality of continuous polymeric filaments can be at least partially bonded to adjacent filaments. According to various embodiments of the process, each of the plurality of continuous polymeric filaments are at least partially bonded to adjacent filaments.

The process can further include entangling the filaments. The entangling can be one of needle-punching and fluid hydroentangement.

The polycarbonate homopolymer component can include a polycarbonate copolymer including bcan bephenol A carbonate units and units of the formula:

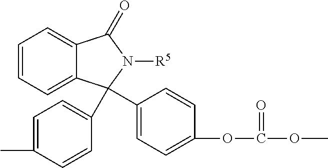

wherein R⁵ can be hydrogen, phenyl optionally substituted with up to five C₁ alkyl groups, or C₁₋₄ alkyl.

The polycarbonate homopolymer component can include a poly(carbonate-siloxane) including bisphenol A carbonate units, and siloxane units of the formula:

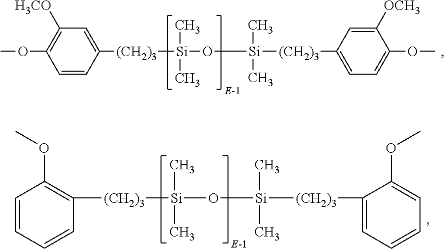

or a combination including at least one of the foregoing, wherein E can have an average value of 2 to 200, wherein the poly(carbonate-siloxane) can include 0.5 to 55 wt. % of siloxane units based on the total weight of the poly(carbonate-siloxane).

The polycarbonate homopolymer component can be a bisphenol polycarbonate. The polycarbonate homopolymer component can be in the form of a solution of the polycarbonate homopolymer component in a solvent.

The process can further include at least partially removing the solvent from the filament before the filament can be deposited. The solvent can be selected from the group of N-Methyl-2-pyrrolidone, chlorinated solvents. The chlorinated solvent can be selected from the group of chloroform, methylene chloride, carbon tetrachloride, tetrachloro ethane, tetrachloro ethylene, dichlorobenzene, chlorobenzene, trichlorobenzene, and combinations thereof.

According to various embodiments, the non-woven web can contain less than 10 wt. %, less than 9 wt. %, less than 8 wt. %, less than 7 wt. %, less than 6 wt. %, less than 5 wt. %, less than 4 wt. %, less than 3 wt. %, less than 2 wt. %, less than 1 wt. %, of a material selected from polyvinyl pyrrolidine, polymethyl methacrylate, polyvinylidene fluoride, polypropylene, polyethylene oxide, agarose, polyvinylidene fluoride, polylactic glycolic acid, nylon 6, polycaprolactone, polylactic acid, polybutylene terepthalate, polyetherimide hornopolymers, polyetherimide co-polymers, polyetherether ketones homopolymers, polyetherether ketones copolymers, polyphenylene sulfones hornopolymers, polyphenylene sulfones copolymers, poly(phenylene ether) components, poly(phenylene ether)-polysiloxane block copolymer, and combinations thereof.

According to various embodiments, the process can exclude any detectable amount of a material selected form polyvinyl pyrrolidine, polymethyl methacrylate, polyvinylidene fluoride, polypropylene, polycarbonate, polyethylene oxide, agarose, polyvinylidene fluoride, polylactic glycolic acid, nylon 6, polycaprolactone, polylactic acid, polybutylene terepthalate, and combinations thereof.

Other embodiments relate to a product produced by the process according to any of other embodiments. The product can be at least one selected from non-woven paper, medical implants, ultra-fine filters, membranes, hospital gowns, electrical insulation paper, honeycomb structures and personal hygiene products, dialyzers, blood, oxygenator filters, intravenous (IV) filters, diagnostic test filters, and blood/apheresis filters. The can be a composite non-woven product including the spun filaments and at least one other fiber. The product can be a composite non-woven product adhered to a rolled sheet good. The product can be a composite non-woven product adhered to at least one of a sheet or film.

The invention is further described in the following illustrative examples in which all parts and percentages are by weight unless otherwise indicated.

### EXAMPLES

Several variations of PC resins were solution spun to average fiber diameters in the sub-micron range. Table 2 provides a list of materials that were employed in the Examples.

TABLE 2

| Component | Chemical Description | Source |
|---|---|---|
| LEXAN ® | Polycarbonate | SABIC |
| Methylene chloride | Dichloromethane | Fisher Scientific |
| | (stabilized, Certified | |
| | ACS) | |
| Chloroform | Chloroform (99%, extra | Acros Organics |
| | pure, stabilized with | |
| | ethanol) | |

Distributions of fiber diameters were measured by imaging the sample using a Phenom Pro Desktop, scanning electron microscope (SEM). A minimum magnification of 140× was used. A minimum of 4 images are retained for fiber diameter analysis. Fiber diameter analysis software (e.g., Fibermetric software) is used to measure the sample's images and at least 100 measurements per image, which are randomly selected by the software, are used in determining the average fiber diameter and distribution.

### Example 1

As an example a solution comprising of 10 wt. % LEXAN® dissolved in methylene chloride was spun through an orifice diameter of 159 μm (30G) at a spinneret speed of 12,000 RPM. This example resulted in fibers with an average diameter of 2.1 μm. FIG. 3 is an image showing the fiber morphology obtained according to Example 1.

### Example 2

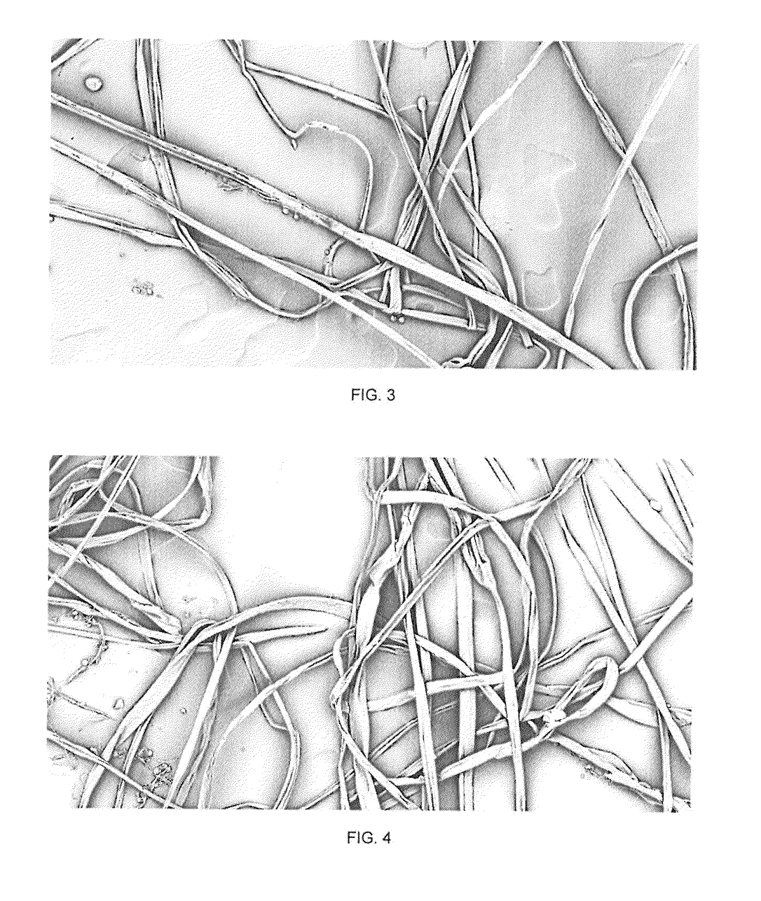

As an example a solution comprising of 10 wt. % LEXAN® dissolved in methylene chloride was spun through an orifice diameter of 210 μm (27G) at a spinneret speed of 12,000 RPM. This example resulted in fibers with an average diameter of 1.1 μm. FIG. 4 is an image showing the fiber morphology obtained according to Example 2.

### Example 3

As an example a solution comprising of 5 wt. % LEXAN® dissolved in methylene chloride was spun through an orifice diameter of 159 μm (30G) at a spinneret speed of 2,000 RPM. The example resulted in no formation of fibers.

### Example 4

As an example a solution comprising of 5 wt. % LEXAN® dissolved in methylene chloride was spun through an orifice diameter of 210 μm (27G) at a spinneret speed of 6,000 RPM. The example resulted in no formation of fibers.

### Example 5

As an example a solution comprising of 15 wt. % LEXAN® dissolved in chloroform was spun through an orifice diameter of 159 μm (30G) at a spinneret speed of 6,000 RPM. The example resulted in no formation of fibers.

Although the present invention has been described in considerable detail with reference to certain preferred versions thereof, other versions are possible. Therefore, the spirit and scope of the appended claims should not be limited to the description of the preferred versions contained herein.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C §112, sixth paragraph. In particular, the use of “step of” in the claims herein is not intended to invoke the provisions of 35 U.S.C §112, sixth paragraph.

What is claimed is:

1. A process comprising:
spinning a plurality of continuous polymeric filaments by passing at least one polymeric component through a spinneret having a plurality of orifices,
wherein the at least one polymeric component comprising a polycarbonate homopolymer component, a polycarbonate copolymer component, and combinations thereof,
wherein each of the plurality of continuous polymeric filaments has a length to diameter ratio that is more than 1,000,000,
wherein each of the plurality of continuous polymeric filaments has a diameter ranging from 50 nanometers to 5 microns,
wherein the spinning is conducted in a non-electrospinning environment,
wherein the spinning is conducted at a rate of at least 300 grams/hour/spinneret; and
producing a non-woven web comprising the plurality of continuous polymeric filaments,
wherein the non-woven web has a width of at least 150 mm.

2. The process of claim 1, wherein producing the non-woven web comprises depositing the plurality of continuous filaments onto one selected from the group consisting of a carrier substrate, a functional sheet, a film, a non-woven, a rolled good product, and combinations thereof.

3. The process of claim 2, wherein the carrier substrate is a reciprocating belt.

4. The process of claim 2, further comprising solidifying the plurality of continuous polymeric filaments before the depositing step.

5. The process of claim 1, wherein the non-woven web is unconsolidated.

6. The process of claim 1, further comprising consolidating the non-woven web.

7. The process of claim 1, further comprising consolidating the non-woven web under pressure.

8. The process of claim 1, wherein the spinning is conducted at a rate of at least 7000 grams/hour/spinneret.

9. The process of claim 1, wherein the spinning is conducted by rotating the spinneret at a speed sufficient to spin the filaments under the effect of centrifugal force.

10. The process of claim 1, wherein each of the plurality of continuous polymeric filaments is provided with at least one additional functionality imparting at least one selected from the group consisting of therapeutic activity, catalytic activity microelectronic activity, micro-optoelectronic activity, magnetic activity, biological activity, and combinations thereof.

11. The process of claim 1, wherein none of the plurality of continuous polymeric filaments are bonded to adjacent filaments.

12. The process of claim 1, wherein a portion of the plurality of continuous polymeric filaments are at least partially bonded to adjacent filaments.

13. The process of claim 1, wherein each of the plurality of continuous polymeric filaments are at least partially bonded to adjacent filaments.

14. The process of claim 1, further comprising entangling the filaments.

15. The process of claim 14, wherein the entangling is one of needle-punching and fluid hydroentangement.

16. The process of claim 1, wherein the polycarbonate homopolymer component comprises a polycarbonate copolymer comprising bisphenol A carbonate units and units of the formula 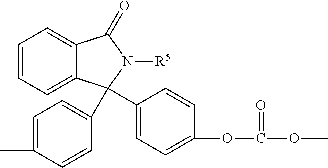
wherein R⁵ is hydrogen, phenyl optionally substituted with up to five C₁₋₁₀ alkyl groups, or C₁₋₄ alkyl;

17. The process of claim 1, wherein the polycarbonate homopolymer component comprises a poly(carbonate-siloxane) comprising
bisphenol A carbonate units, and
siloxane units of the formula 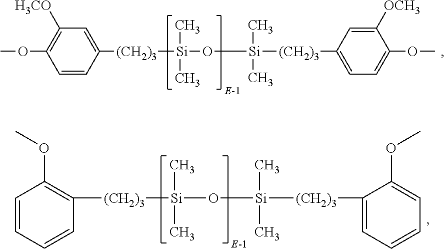
or a combination comprising at least one of the foregoing, wherein E has an average value of 2 to 200, wherein the poly(carbonate-siloxane) comprises 0.5 to 55 wt. % of siloxane units based on the total weight of the poly(carbonate-siloxane)

18. The process of claim 1, wherein the polycarbonate homopolymer component is a bisphenol polycarbonate.

19. The process of claim 1, wherein the polycarbonate homopolymer component is in the form of a solution of the polycarbonate homopolymer component in a solvent.

20. The process of claim 19, further comprising at least partially removing the solvent from the filament before the filament is deposited.

21. The process of claim 19, wherein the solvent is selected from the group of N-Methyl-2-pyrrolidone, chlorinated solvents.

22. The process of claim 21, wherein the chlorinated solvent is selected from the group of chloroform, methylene chloride, carbon tetrachloride, tetrachloro ethane, tetrachloro ethylene, dichlorobenzene, chlorobenzene, trichlorobenzene, and combinations thereof.

23. The process of claim 1, wherein the non-woven web contains less than 10 wt % of a material selected from the group consisting of polyvinyl pyrrolidine, polymethyl methacrylate, polyvinylidene fluoride, polypropylene, polyethylene oxide, agarose, polyvinylidene fluoride, polylactic glycolic acid, nylon 6, polycaprolactone, polylactic acid, polybutylene terepthalate, polyetherimide homopolymers, polyetherimide co-polymers, polyetherether ketones homopolymers, polyetherether ketones copolymers, polyphenylene sulfones homopolymers, polyphenylene sulfones copolymers, poly(phenylene ether) components, poly(phenylene ether)-polysiloxane block copolymer, and combinations thereof.

24. The process of claim 1, wherein the process excludes any detectable amount of a material selected form the group consisting of polyvinyl pyrrolidine, polymethyl methacrylate, polyvinylidene fluoride, polypropylene, polycarbonate, polyethylene oxide, agarose, polyvinylidene fluoride, polylactic glycolic acid, nylon 6, polycaprolactone, polylactic acid, polybutylene terepthalate, and combinations thereof.

25. A product produced by the process of claim 1.

26. The product of claim 25, wherein the product is at least one selected from the group consisting of non-woven paper, medical implants, ultra-fine filters, membranes, hospital gowns, electrical insulation paper, honeycomb structures and personal hygiene products, dialyzers, blood, oxygenator filters, intravenous (IV) filters, diagnostic test filters, and blood/apheresis filters.

27. The product of claim 25, wherein the product is a composite non-woven product comprising the spun filaments and at least one other fiber.

28. The product of claim 25, wherein the product is a composite non-woven product adhered to a rolled sheet good.

29. The product of claim 25, wherein the product is a composite non-woven product adhered to at least one of a sheet or film.

30. A product produced by the process of claim 5.

31. A product produced by the process of claim 6,

32. A product produced by the process of claim 18.

33. A process of forming a non-woven web, said process comprising:
spinning a plurality of continuous polymeric filaments comprising one selected from the group consisting of a polycarbonate homopolymer component, a polycarbonate copolymer component, and combinations thereof,
the filaments having a length to diameter ratio that is more than 1 000,000, and a diameter ranging from 50 nanometers to 5 microns;
said spinning comprising passing a polymer through a spinneret having a plurality of orifices in a non-electrospinning environment;
chopping the plurality of continuous filaments and obtaining a plurality of chopped nano-fibers;
forming the nano-fibers into a non-woven web;
the spinning being conducted at a rate of at least 300 grams/hour/spinneret.

34. The process of claim 33, wherein none of the plurality of continuous polymeric filaments are bonded to adjacent filaments.

35. The process of claim 33, wherein a portion of the plurality of continuous polymeric filaments are at least partially bonded to adjacent filaments.

36. The process of claim 33, wherein each of the plurality of continuous polymeric filaments are at least partially bonded to adjacent filaments.

37. The process of claim 33, further comprising entangling the filaments.

38. The process of claim 33, wherein the non-woven web contains less than 10 wt % of a material selected from the group consisting of polyvinyl pyrrolidine, polymethyl methacrylate, polyvinylidene fluoride, polypropylene, polyethylene oxide, agarose, polyvinylidene fluoride, polylactic glycolic acid, nylon 6, polycaprolactone, polylactic acid, polybutylene terepthalate, polyetherimide homopolymers, polyetherimide co-polymers, polyetherether ketones homopolymers, polyetherether ketones copolymers, polyphenylene sulfones homopolymers, polyphenylene sulfones copolymers, poly(phenylene ether) components, poly(phenylene ether)-polysiloxane block copolymer, and combinations thereof.
